(19) United States
(12) Patent Application Publication
(10) Pub. No.: US 2019/0369820 A1
(43) Pub. Date: Dec. 5, 2019

(54) SUPPORTING DEVICE

(71) Applicant: FANUC CORPORATION, Yamanashi (JP)

(72) Inventors: Syuuzo ADACHI, Yamanashi (JP); Kouji MAEDA, Yamanashi (JP)

(73) Assignee: FANUC CORPORATION, Yamanashi (JP)

(21) Appl. No.: 16/409,897

(22) Filed: May 13, 2019

(30) Foreign Application Priority Data
May 31, 2018 (JP) 2018-104643

(51) Int. Cl. G06F 3/0482

(52) U.S. Cl. CPC G06F 3/0482

(57) ABSTRACT

A supporting device which supports creation of a control panel screen and in which control panel screens can be set easily because the dependency between control panel screens is represented visually whereby a creation time of the control panel screen is shortened and the setting errors of a screen creator can be reduced is provided. A supporting device includes: a screen structure creation unit that creates screen structure information including the dependency between one or more main screens that form a control panel screen and the dependency between the main screens and one or more sub-screens belonging to each of the main screens as screen structure information of the main screens and the sub-screens; a screen structure tree display unit that displays a hierarchical structure between the control panel screens in a tree form on the basis of the dependency included in the screen structure information; and a skeleton project creation unit that creates a skeleton project which is a framework of the control panel screens using the screen switching components, the templates, and the screen structure information on the basis of an operation on a tree displayed by the screen structure tree display unit.

This application is based on and claims the benefit of priority from Japanese Patent Application. No. 2018-104643, filed on 31 May 2018, the content of which is incorporated herein by reference.

### BACKGROUND OF THE INVENTION

### Field of the Invention

The present invention relates to a supporting device that supports creation of a control panel screen used in a control panel of an industrial machine.

### Related Art

When screens displayed on a control panel of an industrial machine to which a numerical controller is connected are implemented, a screen creator designs a screen structure and an operation system and designs display contents of individual screens using screen creation software. When the screen structure and the operation system are designed, the screen creator writes allocation of screens displayed when respective menu buttons are clicked on a sheet or the like and implements the allocation of screens written on the sheet or the like using screen creation software.

For example, Patent Document 1 discloses a controller console (a control panel) including a screen storage means that stores display contents of typical screens of respective menus in correlation in a hierarchical structure form, a manual screen selection means that selects a typical screen of any one of the menus following a path of the hierarchical structure according to keyboard input, and an editor means that edits keyboard data input during displaying of the typical screen selected manually according to the display content to form typical screens for a monitor. In this controller console, typical screens are prepared in advance in correlation in a hierarchical structure form as menus, and when a screen creator selects a predetermined typical screen among the typical screens manually and inputs necessary data, the input data is edited whereby typical screens for a monitor are formed.

Patent Document 1: Japanese Unexamined Utility Model Application Publication No. S63-188704

### SUMMARY OF THE INVENTION

However, although a large number of control panel screens of industrial machines have complex dependency between screens, the screen creation software displays the created screens in a unified manner as a list of screens but it is difficult to display the dependency of the screens visually. Actually, in the technology disclosed in Patent Document 1, it is difficult to display the hierarchical structure of a screen structure visually. Due to this, in the conventional screen creation software, it is difficult to understand an operation system of the entire control panel screen, the screen structures of respective operation systems, and the dependency between all screens.

Moreover, it is necessary to implement a screen switching means and a switching destination screen on each screen as the dependency between screens of the control panel screen. However, when the number of screens increases, since the complexity of the dependency between screens increases, and as a result, the amount of implementation also increases, a creation time increases and the setting errors of a screen creator also increase.

An object of the present invention is to provide a supporting device which supports creation of a control panel screen because the dependency between control panel screens is represented visually and set easily whereby a creation time of the control panel screen is shortened and the setting errors of a screen creator can be reduced.

(1) A supporting device of the present invention is a supporting device (for example, a “supporting device 1” to be described later) that supports creation of control panel screens used in a control panel of an industrial machine, including: a first storage unit (for example, a “screen switching component library 11” to be described later) that stores screen switching components used for switching screens between the control panel screens; a second storage unit (for example, a “template project library 12” to be described later) that stores templates that define a framework of the control panel screens and a layout and a style of the screen switching components on the framework; a screen structure creation unit (for example, a “screen structure creation unit 14” to be described later) that creates screen structure information including the dependency between one or more main screens that form a control panel screen and the dependency between the main screens and one or more sub-screens belonging to each of the main screens as screen structure information of the main screens and the sub-screens; a screen structure tree display unit (for example, a “screen structure tree display unit 15” to be described later) that displays a hierarchical structure between the control panel screens in a tree form on the basis of the dependency included in the screen structure information; and a skeleton project creation unit (for example, a “skeleton project creation unit 16” to be described later) that creates a skeleton project which is a framework of the control panel screens using the screen switching components, the templates, and the screen structure information on the basis of an operation on a tree displayed by the screen structure tree display unit.

(2) In the supporting device according to (1), the screen structure creation unit may execute addition of a new control panel screen and deletion of an existing control panel screen to and from a designated location on the tree.

(3) In the supporting device according to (1) or (2), the screen structure creation unit may set screen transition between the control panel screens on the basis of an operation on the tree.

(4) In the supporting device according to any one of (1) to (3), the skeleton project creation unit may create a skeleton project which is a framework of the control panel screen on the basis of the screen structure information created by the screen structure creation unit.

(5) In the supporting device according to any one of (1) to (4), the skeleton project may include a framework of the main screen, a framework of the sub-screen, a screen classification in which a plurality of main screens having the same object are grouped, and a project screen structure which is an uppermost framework of the skeleton project.

According to the present invention, it is possible to provide a supporting device which supports creation of a control panel screen and which can represent the dependency between screens visually when designing the control panel screen.

### BRIEF DESCRIPTION OF THE DRAWINGS

FIG. 1A is a diagram illustrating an example of a screen structure tree displayed by a supporting device according to an embodiment of the present invention. FIG. 1B is a diagram illustrating icons used in the screen structure tree displayed by the supporting device according to the embodiment of the present Invention. FIG. 2 is a diagram illustrating an entire configuration of the supporting device according to the embodiment of the present invention. FIG. 3A is a flowchart illustrating an operation of a library control unit included in the supporting device according to the embodiment of the present invention. FIG. 3B is a flowchart illustrating an operation of a library control unit included in the supporting device according to the embodiment of the present invention. FIG. 4 is a flowchart illustrating an operation of a screen structure creation unit included in the supporting device according to the embodiment of the present invention. FIG. 5 is a flowchart illustrating an operation of a screen structure creation unit included in the supporting device according to the embodiment of the present invention. FIG. 6 is a flowchart illustrating an operation of a screen structure creation unit included in the supporting device according to the embodiment of the present invention. FIG. 7 is a flowchart illustrating an operation of a screen structure creation unit included in the supporting device according to the embodiment of the present invention. FIG. 8 is a flowchart illustrating an operation of a screen structure creation unit included in the supporting device according to the embodiment of the present invention. FIG. 9A is a flowchart illustrating an operation of a screen structure tree display unit included in the supporting device according to the embodiment of the present invention. FIG. 9B is a flowchart illustrating an operation of a screen structure tree display unit included in the supporting device according to the embodiment of the present invention. FIG. 10A is a flowchart illustrating an operation of a screen structure tree display unit included in the supporting device according to the embodiment of the present invention. FIG. 10B is a flowchart illustrating an operation of a screen structure tree display unit included in the supporting device according to the embodiment of the present invention. FIG. 11A is a flowchart illustrating an operation of a skeleton project creation unit included in the supporting device according to the embodiment of the present invention. FIG. 11B is a flowchart illustrating an operation of a skeleton project creation unit included in the supporting device according to the embodiment of the present invention. FIG. 12 is a flowchart illustrating an operation of a skeleton project creation unit included in the supporting device according to the embodiment of the present invention. FIG. 13 is a diagram illustrating an example of menu buttons created by the skeleton project creation unit included in the supporting device according to the embodiment of the present invention. FIG. 14A is a flowchart illustrating an operation of a skeleton project creation unit included in the supporting device according to the embodiment of the present invention. FIG. 14B is a flowchart illustrating an operation of a skeleton project creation unit included in the supporting device according to the embodiment of the present invention. FIG. 15 is a flowchart illustrating an operation of a skeleton project creation unit included in the supporting device according to the embodiment of the present invention. FIG. 16 is a flowchart illustrating an operation of a skeleton project creation unit included in the supporting device according to the embodiment of the present invention. FIG. 17 is a flowchart illustrating an operation of a skeleton project creation unit included in the supporting device according to the embodiment of the present invention. FIG. 18 is a flowchart illustrating an operation of a skeleton project creation unit included in the supporting device according to the embodiment of the present invention. FIG. 19 is a flowchart illustrating an operation of a skeleton project creation unit included in the supporting device according to the embodiment of the present invention. FIG. 20 is a flowchart illustrating an operation of a skeleton project creation unit included in the supporting device according to the embodiment of the present invention.

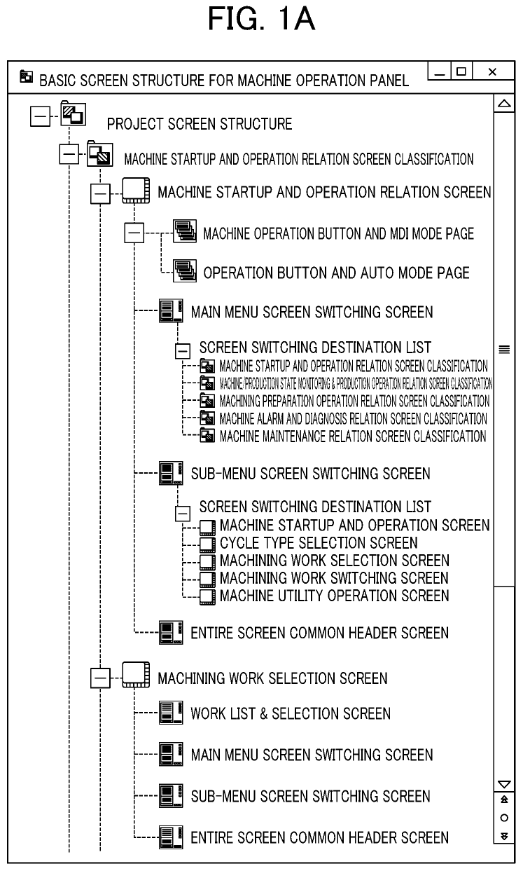

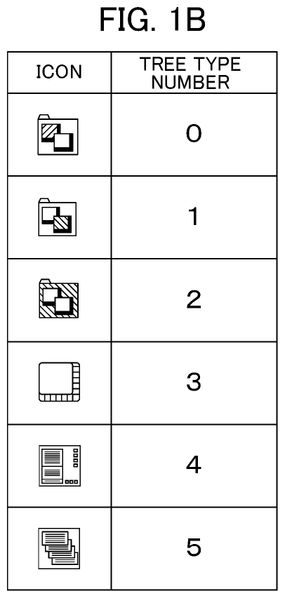

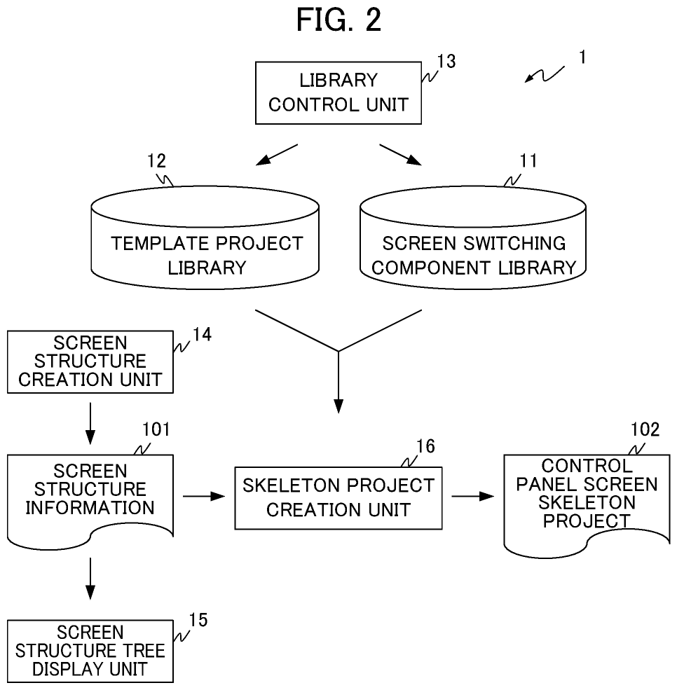

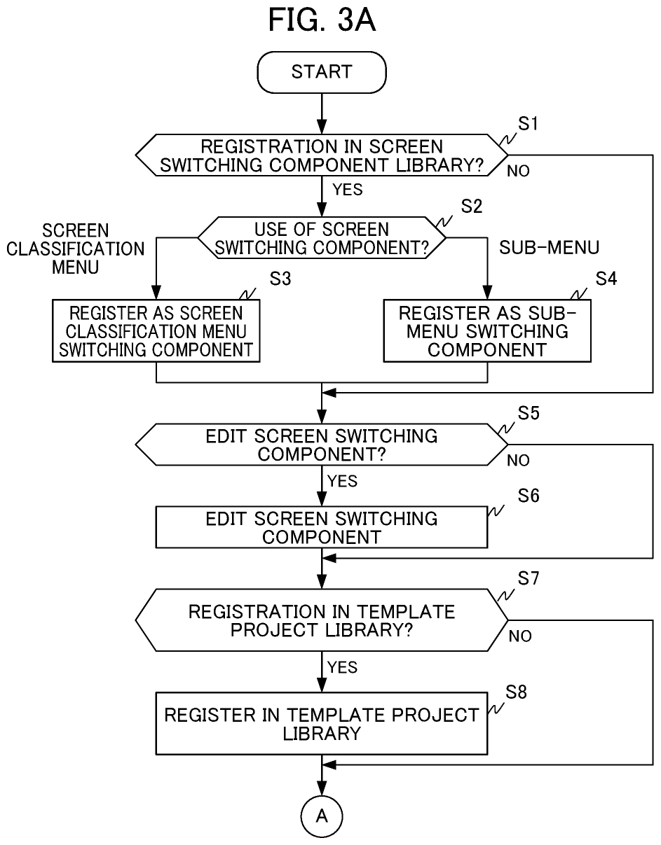

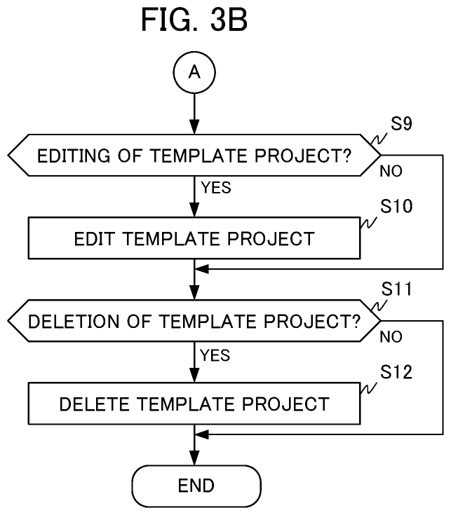

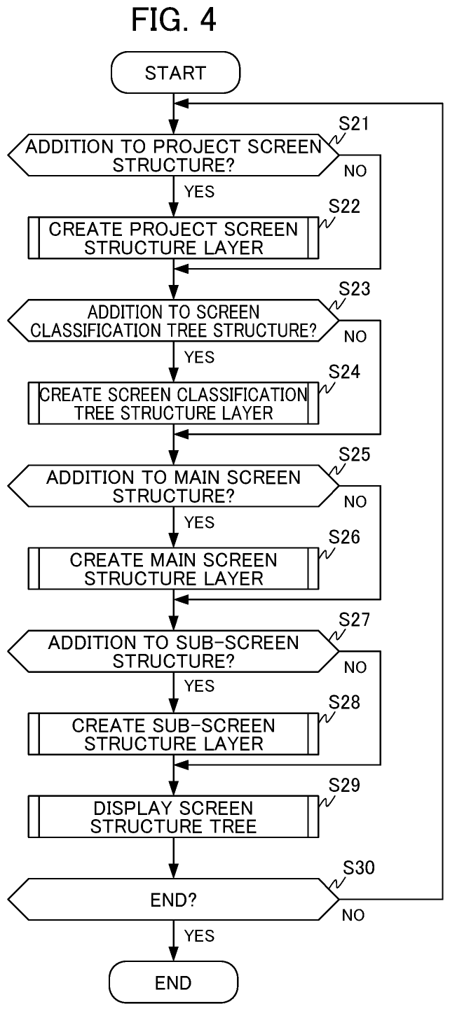

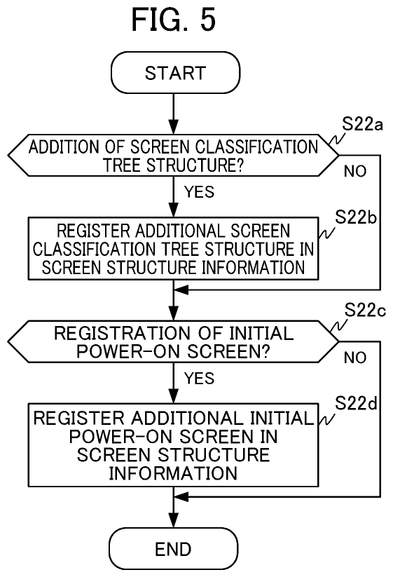

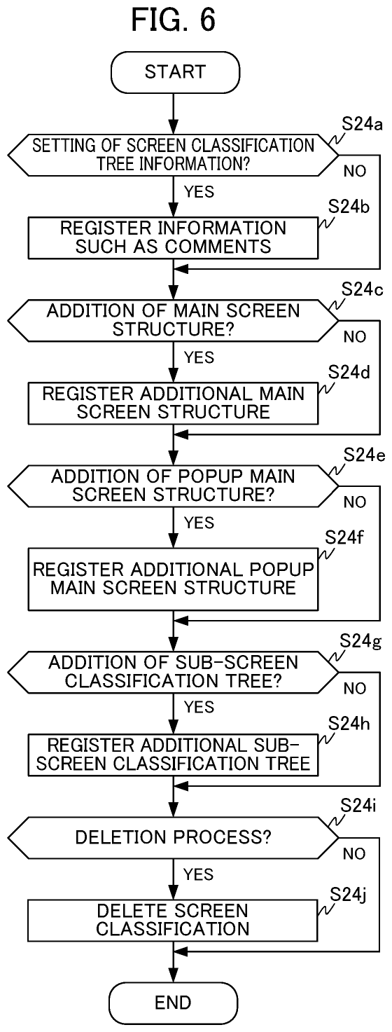

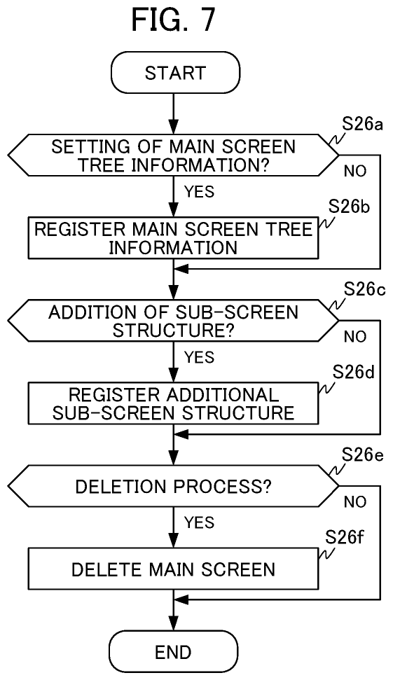

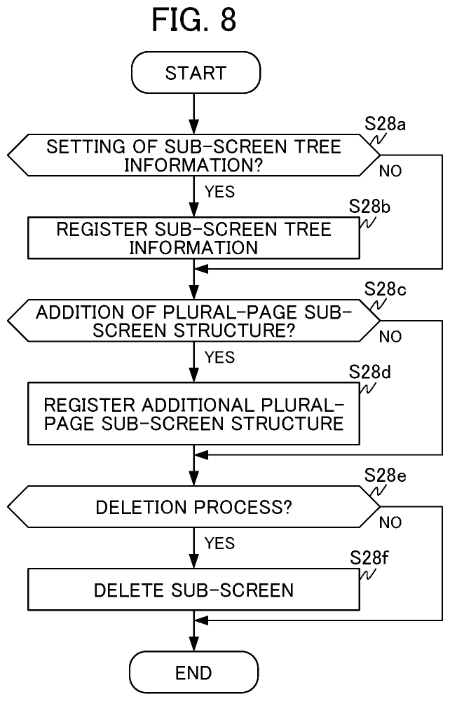

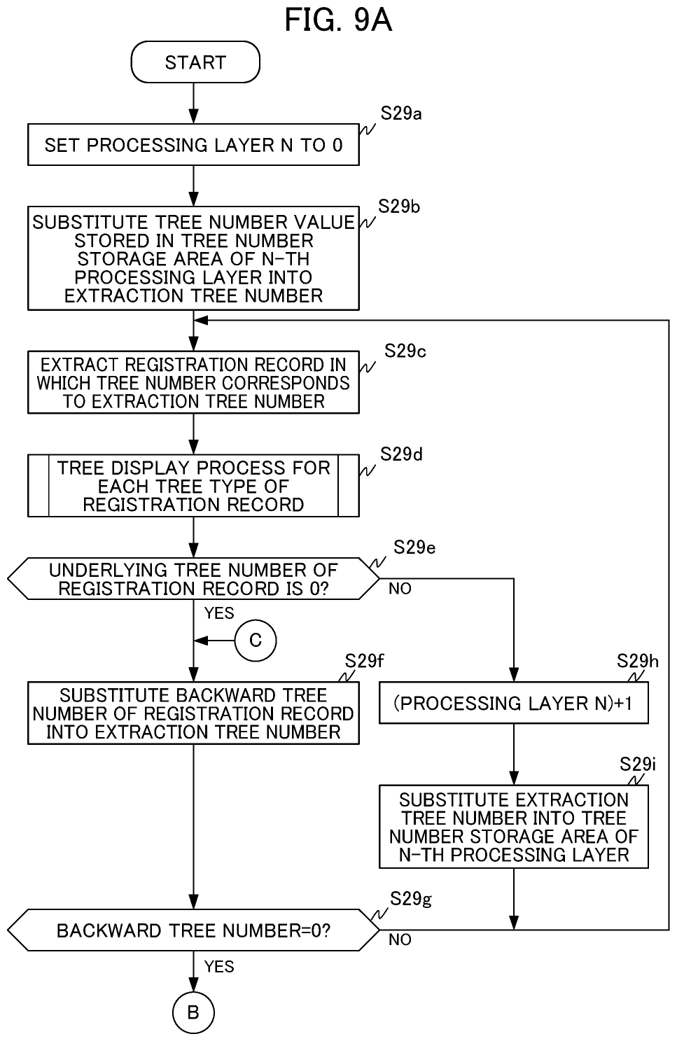

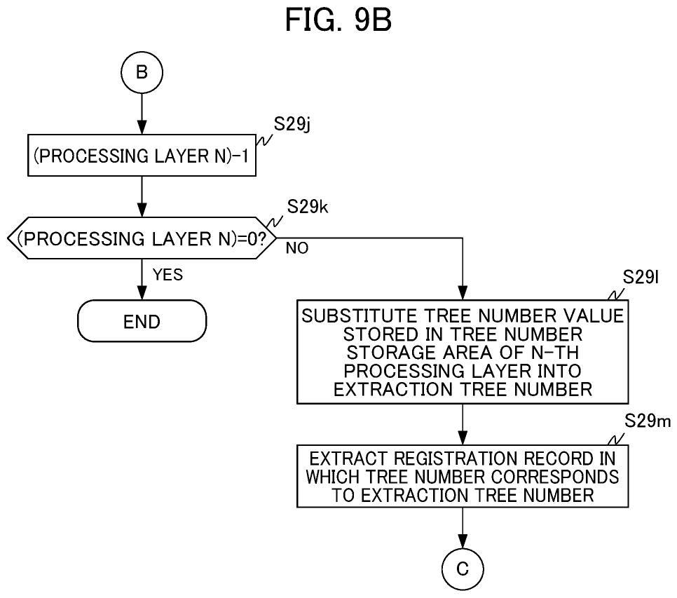

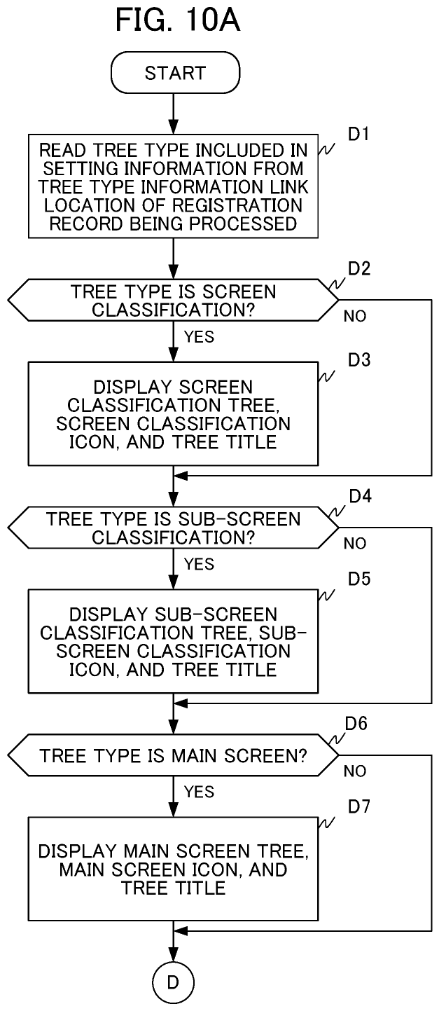

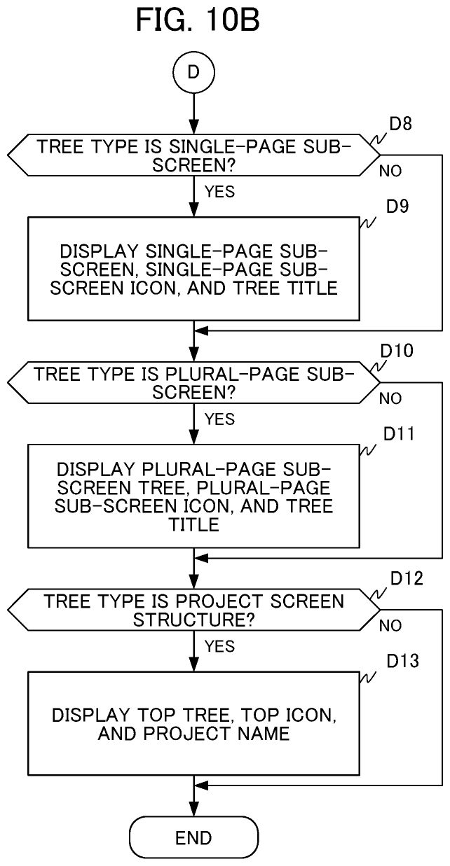

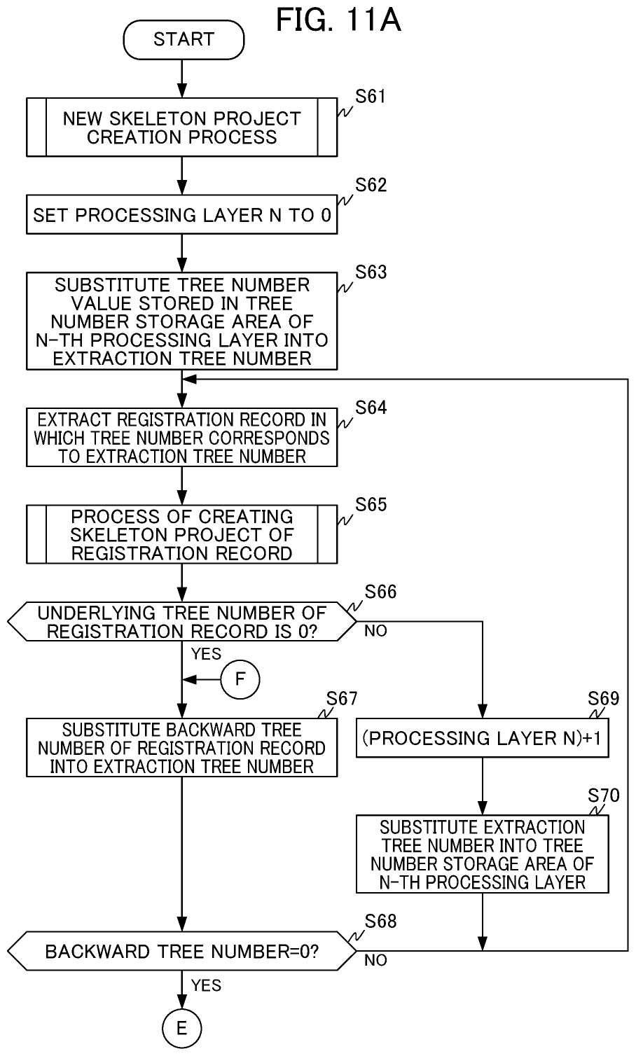

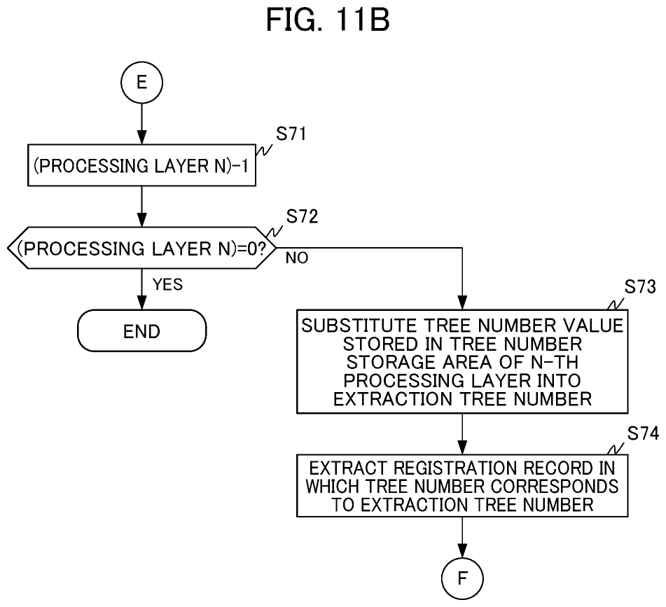

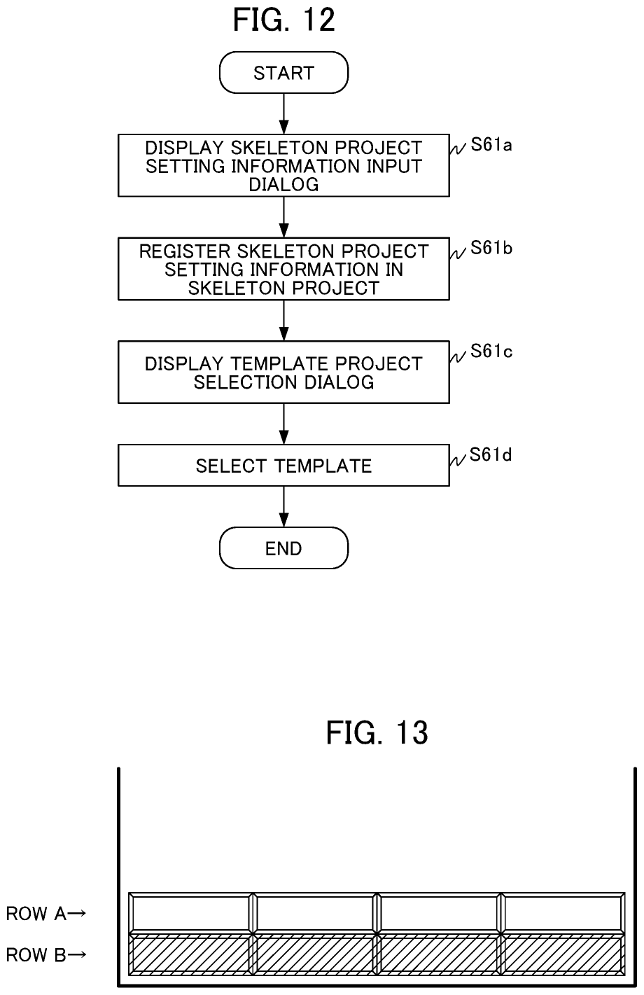

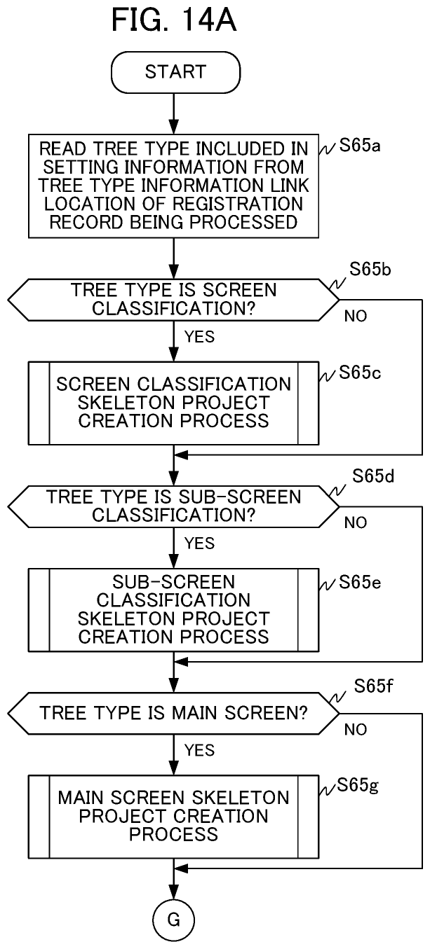

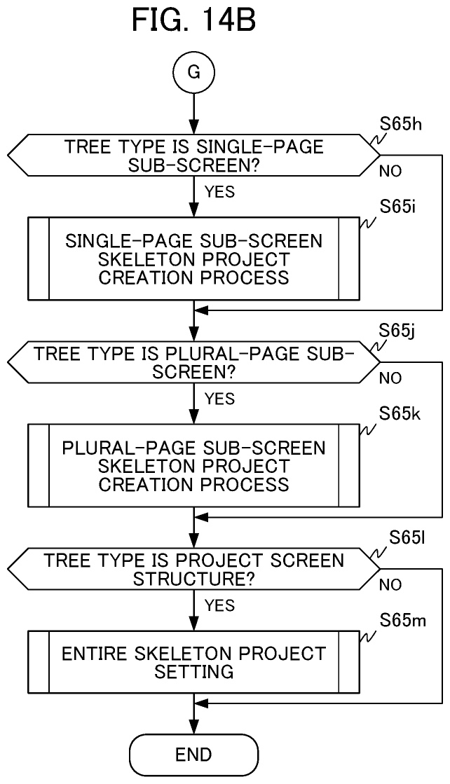

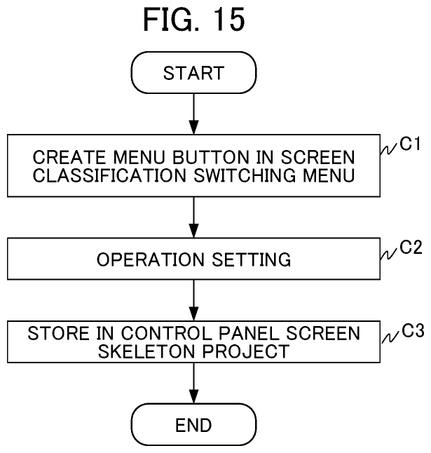

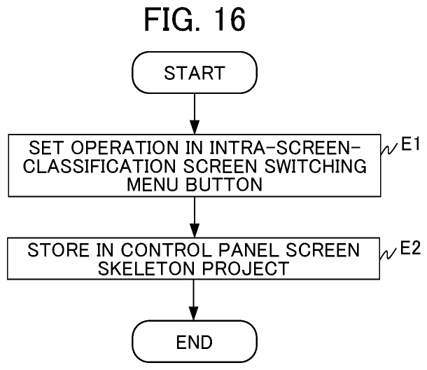

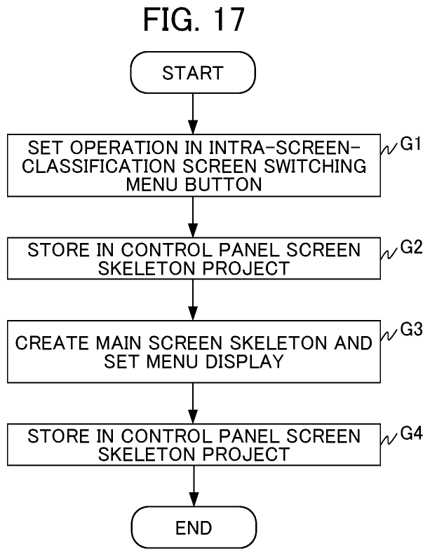

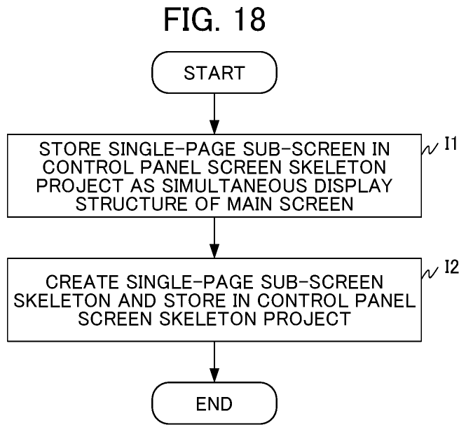

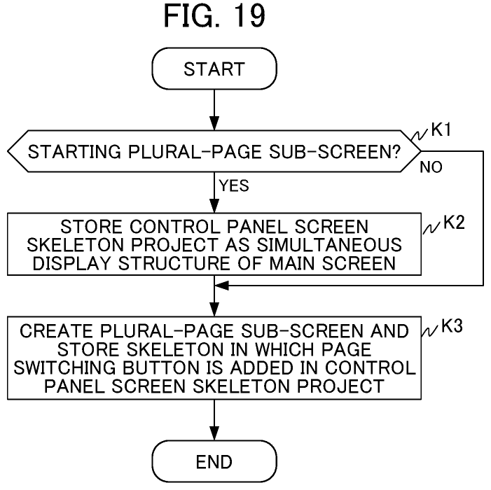

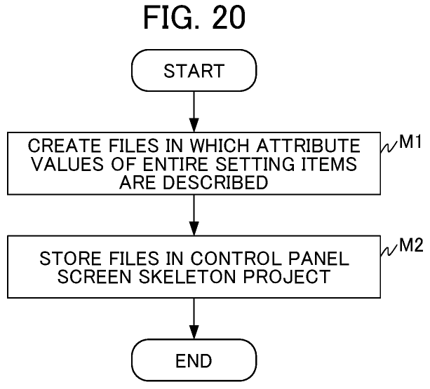

### DETAILED DESCRIPTION OF THE INVENTION Hereinafter, an embodiment of the present invention will be described with reference to FIGS. 1A and 1B to FIG. 20.

### [1. Overview of Invention]

An overview of the present invention will be described with reference to FIGS. 1A and 11. FIG. 1A illustrates a screen structure tree displayed by a supporting device of the present invention and FIG. 1B illustrates the contents of icons illustrated in the screen structure tree of FIG. 1A.

A supporting device of the present invention displays a screen structure of a control panel screen in a tree form in order to support creation of the control panel screen used in a control panel of an industrial machine. In this way, it is possible to understand the dependency between screens visually and understand an entire image of the screen structure. Moreover, in the screen structure tree displayed by the supporting device of the present invention, it is possible to perform screen transition between the screen structure and the screen and create and edit a screen switching means used for the screen transition. In this way, a screen creator creates a skeleton project which is the framework (structure) of the control panel screen. Here, the “skeleton” means the framework (structure) of screens and a menu button is implemented in each skeleton as a screen switching means.

As illustrated in. FIG. 1A, “project screen structure” is at the top of the screen structure tree. The “project screen structure” is the uppermost framework of a skeleton project under creation.

In the example illustrated in FIG. 1A, “machine startup and operation relation screen classification” is an icon one layer below the “project screen structure”, and “machine startup and operation relation screen” and “machining work selection screen” are icons one layer below the “machine startup and operation relation screen classification”. Here, the “machine startup and operation relation screen classification” is illustrated as an icon corresponding to “screen classification”. The “screen classification” is a group of control panel screens having the same object. In the example illustrated in FIG. 1A, the “machine startup and operation relation screen” and the “machining work selection screen” are grouped by the same group of “machine startup and operation relation screen classification” as screens used for machine startup and operation. Moreover, the “machine startup and operation relation screen” and the “machining work selection screen” are illustrated in as icons corresponding to a “main screen”. Here, the “main screen” is a screen used for machine operation itself.

Furthermore, in the example illustrated in FIG. 1A, “machine operation button and MDI mode page”, “operation button and AUTO mode page”, “main menu screen switching screen”, “sub-menu screen switching screen”, and “entire screen common header screen” are icons one layer below the icon of “machine startup and operation relation screen”. This indicates that the “machine startup and operation panel relation screen” includes the “machine operation button and MDI mode page”, the “operation button and AUTO mode page”, the “main menu screen switching screen”, the “sub-menu screen switching screen”, and the “entire screen common header screen”. Here, the “machine operation button and MDI mode page” and the “operation button and AUTO mode page” are illustrated as icons corresponding to “plural-page sub-screen”. The “sub-screen” of the “plural-page sub-screen” means a screen that forms one segment in a main screen, and the “plural-page sub-screen” means that a sub-screen is made up of a plurality of pages switched by a screen switching button. For example, the “machine operation button and MDI mode page” indicates that a plurality of pages in a sub-screen of “MDI mode page” can be switched by a machine operation button.

Moreover, the “main menu screen switching screen”, the “sub-menu screen switching screen”, and the “entire screen common header screen” are illustrated as icons corresponding to a “single-page sub-screen”. The “single-page sub-screen” is a sub-screen similarly to the “plural-page sub-screen” and is a screen made up of one page rather than a plurality of pages.

Moreover, the “main menu screen switching screen” is a screen for switching a main menu screen and a “screen switching destination list” is appended as an attribute thereof. In the example of FIG. 1A, the “screen switching destination list” of the “main menu screen switching screen” includes a “machine startup and operation relation screen classification”, a “machine/production state monitoring & production operation relation screen classification”, a “machining preparation operation relation screen classification”, a “machine alarm and diagnosis relation screen classification”, and a “machine maintenance relation screen classification”. This indicates that the “main menu screen switching screen” can switch screens between the “machine startup and operation relation screen classification”, the “machine production state monitoring & production operation relation screen classification”, the “machining preparation operation relation screen classification”, the “machine alarm and diagnosis relation screen classification”, and the “machine maintenance relation screen classification”. The same is true to the “sub-menu screen switching screen”.

The screen structure tree displayed by the supporting device of the present invention may include icons other than the icons illustrated in the example of FIG. 1A. For example, a “sub-screen classification” may be included in the screen structure as a screen classification one layer below the main screen included in the screen classification, and an icon indicating the “sub-screen classification” may be included in the screen structure tree.

A screen creator can designate an arbitrary location by operating a mouse, for example, on the tree illustrated in the example of FIG. 1A, add a new control panel screen to the designated location, delete an existing control panel screen, and set screen transition between control panel screens. As a method of setting the screen transition, for example, the screen transition between control panel screens can be set by rearranging the order of control panel screens included in the screen switching destination list.

FIG. 1B illustrates an example of a “tree type number” for identifying the type of screen structure trees in which respective icons are at the top thereof. In the example illustrated in FIG. 1B, the “tree type number” of a tree in which the “project screen structure” is at the top thereof is “0”, the “tree type number” of a tree in which the “screen classification” is at the top thereof is “1”, the “tree type number” of a tree in which the “sub-screen classification.” is at the top thereof is “2”, the “tree type number” of a tree in which the “main screen” is at the top thereof is “3”, the “tree type number” of a tree in which the “single-page sub-screen” is at the top thereof is “4”, and the “tree type number” of a tree in which the “plural-page sub-screen” is at the top thereof is “5”

### [2. Overall Configuration]

FIG. 2 illustrates an overall configuration of the supporting device according to the present invention. A supporting device 1 includes a screen switching component library 11, a template project library 12, a library control unit 13, a screen structure creation unit 14, a screen structure tree display unit 15, and a skeleton project creation unit 16.

The screen switching component library 11 is a library including screen switching components such as a screen switching menu and buttons. As the screen switching components, components uniquely designed by users may be registered, and screen data files used by a machine control panel screen creation tool available on the market may be registered. The format of the screen data files may be an xml file format, for example. Moreover, one switching component may include a plurality of components such as buttons and lamps. Furthermore, switching components of the same type and different display sizes may be registered in the screen switching component library 11 as different switching components having unique component names.

The template project library 12 is a library having a template project that defines the style, the layout, and the like of screen switching components in advance during creation of a skeleton project. As a template project, a screen creator can register a project which is designed using a screen switching component registered in the screen switching component library 11.

Moreover, the template project has a data structure including a template project name, a project comment, a screen classification switching menu screen component name, and a main screen switching menu screen component name as a data structure.

The template project name is the name of a template project itself and is used for selecting the template project when creating a skeleton project. The project comment is a comment displayed when the template project is selected. The screen classification switching menu component name includes a screen switching component name registered in the screen switching component library. When a screen switching button for switching a screen classification is created during creation of a skeleton project, a screen switching component included in the screen classification switching menu component name is copied and an operation is set. After that, the screen switching button is registered in the skeleton project. Similarly, the main screen switching menu component name also includes a screen switching component name registered in the screen switching component library. When a screen switching button for switching a main screen is created during creation of a skeleton project, a screen switching component included in the main screen switching menu component name is copied and an operation is set. After that, the screen switching button is registered in the skeleton project.

The library control unit 13 registers a screen switching component in the screen switching component library 11 and registers a template project in the template project library 12. Moreover, the library control unit 13 edits the screen switching component registered in the screen switching component library 11 and edits the template project registered in the template project library 12. Furthermore, the library control unit 13 creates a screen switching component to be registered in the screen switching component library 11 and creates a template project to be registered in the template project library 12.

The screen structure creation unit 14 generates the dependency between a plurality of main screens that forms a control panel screen and the sub-screens belonging to the respective main screens on the basis of the settings set by the screen creator as screen structure information 101. Here, for example, when the main screen is an NC program editing screen, the sub-screen is an NC program list screen or the like. Moreover, the screen structure creation unit 14 generates information related to hardware performance and properties of a control panel display on the basis of the input from the screen creator as the screen structure information 101. Furthermore, the screen structure creation unit 14 generates an inter-screen switching means and information related to a switching destination or information such as comments on each screen on the basis of the input from the screen creator as the screen structure information 101. In this way, the screen structure creation unit 14 substantially executes addition of a new control panel screen and deletion of an existing control panel screen in a designated location on the screen structure tree and sets screen transition between control panel screens.

The screen structure information 101 has a data structure including a tree number, a backward tree number, an underlying tree number, a forward tree number, a tree type number, and a tree type information link location as a data structure of registration records registered thereto. The tree number is a serial number of a registration record registered in the screen structure information 101. When a tree which is on the same level as a tree corresponding to a registration record and which is connected to a backward side of the tree is present, a tree number of the backward tree is recorded in the backward tree number. When the backward tree number is 0, it indicates that a backward tree is not present. When a tree connected to a tree one layer below a registration record is present, a tree number of the one-layer-below tree is recorded in the underlying tree number. When the underlying tree number is 0, it indicates that an underlying tree is not present. When a tree which is on the same level as a tree corresponding to a registration record and which is connected to a forward side of the tree is present or a tree connected to a tree one layer above the tree corresponding to the registration record is present, a tree number of these forward trees or the one-layer-above tree is recorded in the forward tree number. The tree type number indicates the type of a tree. As described above, FIG. 1B illustrates examples of tree type numbers. The location and the name of a separate file that stores the content set in the screen structure information 101 are recorded in the tree type information link location. A screen name or the like of the tree display is also recorded in the separate file.

The screen structure tree display unit 15 displays a screen structure in a tree form on the basis of the screen structure information 101 created by the screen structure creation unit 14. FIG. 1A is an example of a tree that is visually displayed by the screen structure tree display unit 15.

The skeleton project creation unit 16 creates a control panel screen skeleton project 102 using the screen switching component registered in the screen switching component library 11, the template project registered in the template project library 12, and the screen structure information 101. Here, the skeleton project creation unit 16 can create the control panel screen skeleton project 102 on the basis of the operation of the screen creator on the tree displayed by the screen structure tree display unit 15.

### [3. Operations of Respective Units]

Hereinafter, the operations of respective units that form the supporting device 1 will be described with reference to FIGS. 3A to 20.

### [3.1 Operation of Library Control Unit]

FIGS. 3A and 3B are flowcharts illustrating an operation of the library control unit 13. In step S1, when the library control unit 13 registers a screen switching component in the screen switching component library 11 (S1: YES), the flow proceeds to step S2. When the library control unit 13 does not register a screen switching component in the screen switching component library 11 (S1: NO), the flow proceeds to step S5.

In step S2, when the switching component is a switching component for screen classification menus, the flow proceeds to step S3. When the switching component is a switching component for sub-menus, the flow proceeds to step S4. The “sub-menu” will be described later with reference to FIG. 13.

In step S3, the library control unit 13 registers the screen switching component in the screen switching component library 11 as a switching component for screen classification menus.

In step S4, the library control unit 13 registers the screen switching component in the screen switching component library 11 as a switching component for sub-menus.

In step S5, when the library control unit 13 edits a screen switching component (S5: YES), the flow proceeds to step S6. When the library control unit 13 does not edit the screen switching component (S5: NO), the flow proceeds to step S7. In step S6, the library control unit 13 edits the screen switching component.

In step S7, when the library control unit 13 registers a template project in the template project library 12 (S7: YES), the flow proceeds to step S8. When the library control unit 13 does not register the template project in the template project library 12 (57: NO), the flow proceeds to step S9. In step S8, the library control unit 13 registers the template project in the template project library 12.

In step S9, when the library control unit 13 edits the template project (S9: YES), the flow proceeds to step S10. When the library control unit 13 does not edit the template project (S9: NO), the flow proceeds to step S11. In step S10, the library control unit 13 edits the template project.

In step S11, when the library control unit 13 deletes the template project (S11: YES), the flow proceeds to step S12. When the library control unit 13 does not delete the template project (S11: NO), the flow ends. In step S12, the library control unit 13 deletes the template project.

### [3.2 Operations of Screen Structure Creation Unit and Screen Structure Tree Display Unit]

FIG. 4 is a flowchart illustrating the operations of the screen structure creation unit 14 and the screen structure tree display unit 15. In step S21, when the screen structure creation unit 14 adds a project screen structure layer to the project screen structure (S21: YES), the flow proceeds to step S22. When the screen structure creation unit 14 does not add the project screen structure layer to the project screen structure (S21: NO), the flow proceeds to step S23.

In step S22, the screen structure creation unit 14 creates a project screen structure layer. The details of a project screen structure layer creation operation will be described later with reference to FIG. 5.

In step S23, when the screen structure creation unit 14 adds a screen classification tree structure layer to a screen classification tree structure (S23: YES), the flow proceeds to step S24. When the screen structure creation unit 14 does not add the screen classification tree structure layer to the screen classification tree structure (S23: NO), the flow proceeds to step S25.

In step S24, the screen structure creation unit 14 creates the screen classification tree structure layer. The details of the screen classification tree structure layer creation operation will be described later with reference to FIG. 6.

In step S25, when the screen structure creation unit 14 adds a main screen structure layer to a main screen structure (S25: YES), the flow proceeds to step S26. When the screen structure creation unit 14 does not add the main screen structure layer to the main screen structure (S25: NO), the flow proceeds to step S27.

In step S26, the screen structure creation unit 14 creates a main screen structure layer. The details of a main screen structure layer creation operation will be described later with reference to FIG. 7.

In step S27, when the screen structure creation unit 14 adds a sub-screen structure layer to a sub-screen structure (S27: YES), the flow proceeds to step S28. When the screen structure creation unit 14 does not add the sub-screen structure layer to the sub-screen structure (S27: NO), the flow proceeds to step S29.

In step S28, the screen structure creation unit 14 creates the sub-screen structure layer. The details of a sub-screen structure layer creation operation will be described later with reference to FIG. 8.

In step S29, the screen structure tree display unit 15 displays a screen structure tree. The details of a screen structure tree displaying operation will be described later with reference to FIGS. 9A and 9B.

FIG. 5 is a flowchart illustrating the details of a project screen structure layer creation operation of step S22. In step S22a, when the screen structure creation unit 14 adds a screen classification tree structure to a project screen structure as a project screen structure layer (S22a: YES), the flow proceeds to step S22b. When the screen structure creation unit 14 does not add a screen classification tree structure to the project screen structure (S22a: NO), the flow proceeds to step S22c.

In step S22b, the screen structure creation unit 14 generates the screen structure information 101 so that a screen classification tree structure is additionally registered in the project screen structure as a project screen structure layer.

In step S22c, when the screen structure creation unit 14 registers an initial power-on screen (a top screen of a screen structure tree) in the project screen structure (S22c: YES), the flow proceeds to step S22d. When the screen structure creation unit 14 does not register the initial power-on screen in the project screen structure (S22c: NO), the flow ends.

In step S22d, the screen structure creation unit 14 generates the screen structure information 101 so that an initial power-on screen is additionally registered in the project screen structure.

FIG. 6 is a flowchart illustrating the details of a screen classification tree structure layer creation operation of step S24. In step S24a, when the screen structure creation unit 14 sets screen classification tree information in the screen classification tree structure (S24a: YES), the flow proceeds to step S24b. When the screen structure creation unit 14 does not set the screen classification tree information in the screen classification tree structure (S24a: NO), the flow proceeds to step S24c.

In step S24b, the screen structure creation unit 14 registers comments or the like in the screen structure information 101 as screen classification tree information of a screen classification tree corresponding to a designated location touched within the displayed screen structure tree.

In step S24c, when the screen structure creation unit 14 adds a main screen structure to the screen classification tree structure as a screen classification tree structure layer (S24c: YES), the flow proceeds to step S24d. When the screen structure creation unit 14 does not add the main screen structure to the screen classification tree structure (S24c: NO), the flow proceeds to step S24e.

In step S24d, the screen structure creation unit 14 generates the screen structure information 101 so that a main screen structure is additionally registered in the designated location touched within the displayed screen classification tree as a screen classification tree structure layer.

In step S24e, when the screen structure creation unit 14 adds a popup main screen structure which is one kind of a main screen structure to the screen classification tree structure as the screen classification tree structure layer (S24e: YES), the flow proceeds to step S24f. When the screen structure creation unit 14 does not add the popup main screen structure to the screen classification tree structure (S24e: NO), the flow proceeds to step S24f. The “popup main screen structure” is a main screen displayed as a popup.

In step S24f, the screen structure creation unit 14 generates the screen structure information 101 so that a popup main screen structure is additionally registered in a designated location touched within the displayed screen classification tree as a screen classification tree structure layer.

In step S24g, when the screen structure creation unit 14 adds a sub-screen tree structure to the screen classification tree structure as a screen classification tree structure layer (S24g: YES), the flow proceeds to step S24h. When the screen structure creation unit 14 does not add the sub-screen tree structure to the screen classification tree structure (S24g: NO), the flow proceeds to step S24i.

In step S24h, the screen structure creation unit 14 generates the screen structure information 101 so that a sub-screen tree structure is additionally registered in a designated location touched within the displayed screen classification tree as a screen classification tree structure layer.

In step S24i, when the screen structure creation unit 14 deletes a screen classification (S24i: YES), the flow proceeds to step S24j. When the screen structure creation unit 14 does not delete the screen classification (S24i: NO), the flow ends.

In step S24j, the screen structure creation unit 14 generates the screen structure information 101 so that a screen classification is deleted from the designated location touched within the screen structure tree displayed by the screen structure tree display unit 15.

FIG. 7 is a flowchart illustrating the details of a main screen structure layer creation operation of step S26. In step S26a, when the screen structure creation unit 14 sets main screen tree information in a main screen tree structure (S26a: YES), the flow proceeds to step S26b. When the screen structure creation unit 14 does not set the main screen tree information in the main screen tree structure (S26a: NO), the flow proceeds to step S26c.

In step S26b, the screen structure creation unit 14 registers comments or the like in the screen structure information 101 as main screen tree information corresponding to a designated location touched within the displayed tree.

In step S26c, when the screen structure creation unit 14 adds a sub-screen structure to a main screen tree structure as a main screen tree structure layer (S26c: YES), the flow proceeds to step S26d. When the screen structure creation unit 14 does not add the sub-screen structure to the main screen tree structure (S26c: NO), the flow proceeds to step S26e.

In step S26d, the screen structure creation unit 14 generates the screen structure information. 101 so that a sub-screen structure is additionally registered in the designated location touched within the displayed main screen tree as a main screen tree structure layer.

In step S26e, when the screen structure creation unit 14 deletes a main screen (S26e: YES), the flow proceeds to step S26f. When the screen structure creation unit 14 does not delete the main screen (S26e: NO), the flow ends.

In step S26f, the screen structure creation unit 14 generates the screen structure information 101 so that the main screen is deleted from the designated location touched within the screen structure tree displayed by the screen structure tree display unit 15.

FIG. 8 is a flowchart illustrating the details of a sub-screen structure layer creation operation in step S28. In step S28a, when the screen structure creation unit 14 sets sub-screen tree information in the sub-screen tree structure (S28a: YES), the flow proceeds to step S28b. When the screen structure creation unit 14 does not set the sub-screen tree information in the sub-screen tree structure (S28a: NO), the flow proceeds to step S28c.

In step S28b, the screen structure creation unit 14 registers comments or the like in the screen structure information 101 as information related to a sub-screen tree corresponding to the designated location touched within the displayed tree.

In step S28c, when the screen structure creation unit 14 adds a plural-page sub-screen structure to the sub-screen tree structure as a sub-screen tree structure layer (S28c: YES), the flow proceeds to step S28d. When the screen structure creation unit 14 does not add the plural-page sub-screen structure to the sub-screen tree structure (S28c: NO), the flow proceeds to step S28e.

In step S28d, the screen structure creation unit 14 generates the screen structure information 101 so that a plural-page sub-screen structure is additionally registered in the designated location touched within the displayed main screen tree as a sub-screen tree structure layer.

In step S28e, when the screen structure creation unit 14 deletes a sub-screen (a single-page sub-screen or a plural-page sub-screen) (S28e: YES), the flow proceeds to step S28f. When the screen structure creation unit 14 does not delete the sub-screen (S28e: NO), the flow ends.

In step S28f, the screen structure creation unit 14 generates the screen structure information 101 so that a sub-screen (a single-page sub-screen or a plural-page sub-screen) is deleted from the designated location touched within the screen structure tree displayed by the screen structure tree display unit 15.

FIGS. 9A to 10B are flowcharts illustrating the details of a screen structure tree displaying operation in step S29. In step S29a, the screen structure tree display unit 15 sets the value of a processing layer N to 0 as an initial setting value.

In step S29b, the screen structure tree display unit 15 substitutes the value of a tree number stored in a tree number storage area of an N-th processing layer into an extraction tree number. Here, the “tree number storage area” is an area in which an extraction tree number being processed is stored whenever an underlying tree number appears.

In step S29c, the screen structure tree display unit 15 extracts a registration record in which a tree number corresponds to an extraction tree number.

In step S29d, the screen structure tree display unit 15 executes a tree displaying process for each of the tree types described in the registration record. The details of the tree displaying process for respective tree types will be described later with reference to FIGS. 10A and 10B.

In step S29e, when the underlying tree number of a registration record is 0 (S29e: YES), the flow proceeds to step S29f. When the underlying tree number of the registration record is not 0 (S29e: NO), the flow proceeds to step S29h.

In step S29f, the screen structure tree display unit 15 substitutes a backward tree number described in the registration record into the extraction tree number.

In step S29g, when the backward tree number is 0 (S29g: YES), the flow proceeds to step S29j. When the backward tree number is not 0 (S29g: NO), the flow proceeds to step S29c.

In step S29h, the screen structure tree display unit 15 adds 1 to the processing layer N. In step S29i, the screen structure tree display unit 15 substitutes the extraction tree number into the tree number storage area of the N-th processing layer. After that, the flow proceeds to step S29c.

In step S29j, the screen structure tree display unit 15 subtracts 1 from the processing layer N. In step S29k, when the processing layer N is 0 (529k: YES), the flow ends. When the processing layer N is not 0 (S29k: NO), the flow proceeds to step S29l.

In step S29l, the screen structure tree display unit 15 substitutes the value of a tree number stored in the tree number storage area of the N-th processing layer into the extraction tree number.

In step S29m, the screen structure tree display unit 15 extracts a registration record in which a tree number corresponds to the extraction tree number. After that, the flow proceeds to step S29f.

FIGS. 10A and 10B are flowcharts illustrating the details of the tree displaying process for respective tree types in step S29d.

In step D1, the screen structure tree display unit 15 reads a tree type included in the setting information from a tree type information link location of the registration record being processed.

In step D2, when the tree type is a screen classification (D2: YES), the flow proceeds to step D3. When the tree type is not a screen classification (D2: NO), the flow proceeds to step D4.

In step D3, the screen structure tree display unit 15 displays a screen classification tree, a screen classification icon, and a tree title.

In step D4, when the tree type is a sub-screen classification (D4: YES), the flow proceeds to step D5. When the tree type is not the sub-screen classification (D4: NO), the flow proceeds to step D6.

In step D5, the screen structure tree display unit 15 displays a sub-screen classification tree, a sub-screen classification icon, and a tree title.

In step D6, when the tree type is a main screen (D6: YES), the flow proceeds to step D7. When the tree type is not a main screen. (D6: NO), the flow proceeds to step D8.

In step D7, the screen structure tree display unit 15 displays a main screen tree, a main screen icon, and a tree title.

In step D8, when the tree type is a single-page sub-screen (D8: YES), the flow proceeds to step D9. When the tree type is not a single-page sub-screen (D8: NO), the flow proceeds to step D10.

In step D9, the screen structure tree display unit 15 displays a single-page sub-screen tree, a single-page sub-screen icon, and a tree title.

In step D10, when the tree type is a plural-page sub-screen (D10: YES), the flow proceeds to step D11. When the tree type is not, a plural-page sub-screen (D10: NO), the flow proceeds to step D12.

In step D11, the screen structure tree display unit 15 displays a plural-page sub-screen tree, a plural-page sub-screen icon, and a tree title.

In step D12, when the tree type is a project screen structure (D12: YES), the flow proceeds to step D13. When the tree type is not a project screen structure (D12: NO), the flow ends.

In step D13, the screen structure tree display unit 15 displays a top tree, a top icon, and a project name.

### [3.3 Operation of Skeleton Project Creation Unit]

FIGS. 11A and 11B are flowcharts illustrating an operation of the skeleton project creation unit 16. In step S61, the skeleton project creation unit 16 executes a new skeleton project creation process. The details of the new skeleton project creation process will be described later with reference to FIG. 12.

In step S62, the skeleton project creation unit 16 sets the value of the processing layer N to 0 as an initial setting value.

In step S63, the skeleton project creation unit 16 substitutes the value of a tree number stored in the tree number storage area of the N-th processing layer into the extraction tree number. Here, the tree number storage area is an area in which an extraction tree number being processed is stored whenever an underlying tree number appears.

In step S64, the skeleton project creation unit 16 extracts a registration record in which a tree number corresponds to an extraction tree number.

In step S65, the skeleton project creation unit 16 executes a process of creating a skeleton project in the extracted registration record. The details of the skeleton project creation process will be described later with reference to FIGS. 14A and 14B.

In step S66, when an underlying tree number of a registration record is 0 (S66: YES), the flow proceeds to step S67. When the underlying tree number of the registration record is not 0 (S66: NO), the flow proceeds to step S69.

In step S67, the skeleton project creation unit 16 substitutes a backward tree number described in the registration record into the extraction tree number.

In step S68, when the backward tree number is not 0(S68: YES), the flow proceeds to step S71. When the backward tree number is not 0 (S68: NO), the flow proceeds to step S64.

In step S69, the skeleton project creation unit 16 adds 1 to the processing layer N. In step S70, the skeleton project creation unit 16 substitutes an extraction tree number into the tree number storage area of the N-th processing layer. After that, the flow proceeds to step S64.

In step S71, the skeleton project creation unit 16 subtracts 1 from the processing layer N. In step S72, when the processing layer N is 0 (S72: YES), the flow ends. When the processing layer N is not 0 (S72: NO), the flow proceeds to step S73.

In step S73, the skeleton project creation unit 16 substitutes the value of a tree number stored in the tree number storage area of the N-th processing layer into the extraction tree number.

In step S74, the skeleton project creation unit 16 extracts a registration record in which a tree number corresponds to an extraction tree number. After that, the flow proceeds to step S67.

FIG. 12 is a flowchart illustrating the details of a new skeleton project creation process of step S61.

In step S61a, the skeleton project creation unit 16 displays an input dialog for inputting the setting information of the skeleton project.

In step S61b, the skeleton project creation unit 16 registers the setting information input from the input dialog by a screen creator in the skeleton project.

In step S61c, the skeleton project creation unit 16 displays a selection dialog for allowing a screen creator to select a template project.

In step S61d, the screen creator selects a template. Specifically, the screen creator selects a model or a shape of a menu button as a screen switching component included in the template, for example. FIG. 13 illustrates an example of how a template including a menu button and the shape of the menu button are selected. Row A is a main menu and row B is a sub-menu. Specifically, the menu button on row A is a menu button for switching screen classifications and the menu button on row B is a menu button for switching main screens included in a screen classification and switching sub-screen classifications.

FIGS. 14A and 14B are flowcharts illustrating the details of a skeleton project creation process of step S65.

In step S65a, the skeleton project creation unit 16 reads a tree type included in the setting information from a tree type information link location of the registration record being processed.

In step S65b, when the tree type is a screen classification (S65b: YES), the flow proceeds to step S65c. When the tree type is not a screen classification (S65b: NO), the flow proceeds to step S65d.

In step S65c, the skeleton project creation unit 16 executes a screen classification skeleton project creation process. The details of the screen classification skeleton project creation process will be described later with reference to FIG. 15.

In step S65d, when the tree type is a sub-screen classification (S65d: YES), the flow proceeds to step S65e. When the tree type is not a sub-screen classification (S65d: NO), the flow proceeds to step S65f.

In step S65e, the skeleton project creation unit 16 executes a sub-screen classification skeleton project creation Process. The details of the sub-screen classification skeleton project creation process will be described later with reference to FIG. 16.

In step S65f, when the tree type is a main screen (S65f: YES), the flow proceeds to step S65g. When the tree type is not a main screen (S65f: NO), the flow proceeds to step S65h.

In step S65g, the skeleton project creation unit 16 executes a main screen skeleton project creation process. The details of the main screen skeleton project creation process be described later with reference to FIG. 17.

In step S65h, when the tree type is a single-page sub-screen (S65h: YES), the flow proceeds to step S65i. When the tree type is not a single-page sub-screen (S65h: NO), the flow proceeds to step S65j.

In step S65i, the skeleton project creation unit 16 executes a single-page sub-screen skeleton project creation process. The details of the single-page sub-screen skeleton project creation process will be described later with reference to FIG. 18.

In step S65j, when the tree type is a plural-page sub-screen (S65j: YES), the flow proceeds to step S65k. When the tree type is not a plural-page sub-screen (S65j: NO), the flow proceeds to step S65l.

In step S65k, the skeleton project creation unit 16 executes a plural-page sub-screen skeleton project creation process. The details of the plural-page sub-screen skeleton project creation process will be described later with reference to FIG. 19.

In step S65l, when the tree type is a project screen structure (S65l: YES), the flow proceeds to step S65m. When the tree type is not a project screen structure (S65l: NO), the flow ends.

In step S65m, the skeleton project creation unit 16 executes an entire skeleton project setting process. The details of the entire skeleton project setting process will be described later with reference to FIG. 20.

FIG. 15 is a flowchart illustrating the details of a screen classification skeleton project creation process of step S65c. In step C1, the skeleton project creation unit 16 creates a menu button in a screen classification switching menu included in a screen classification skeleton project.

In step C2, the skeleton project creation unit 16 sets operations of the menu button created in step C1 so that when the menu button is pressed, the screen is switched to a main screen included in the screen classification and the main screen is displayed.

An example of the menu button will be described with reference to FIG. 13. For example, in a screen classification switching menu on row A, a screen classification switching menu button can be set from the left in an extraction order of the screen classification structures. Moreover, when there are a number of screen classifications, a new menu switching button for switching to a screen classification switching menu on row A can be set in the menu button of a right-end menu on row A to create the new screen classification switching menu on row A, and an extracted screen classification switching menu button can be set from the left end.

In step C3, the skeleton project creation unit 16 stores the created menu in the control panel screen skeleton project 102.

FIG. 16 is a flowchart illustrating the details of a sub-screen classification skeleton project creation process of step S65e.

In step E1, the skeleton project creation unit 16 sets an intra-sub-screen-classification screen switching operation in the menu button of an intra-screen-classification screen switching menu included in the sub-screen classification skeleton project.

An example of the menu button will be described with reference to FIG. 13. For example, in an intra-screen-classification screen switching menu on row B, a menu button for switching to a sub-screen classification can be set from the left in an extraction order of the main screens and the sub-screen classifications. Moreover, when there are a number of main screens and sub-screen classifications, a menu switching button for switching a new intra-screen classification screen switching menu on row B can be set in a menu button of a right-end menu on row B to create the new intra-screen-classification screen switching menu on row B, and a menu button for switching to an extracted sub-screen classification can be set from the left end.

In step P2, the skeleton project creation unit. 16 stores the created menu in the control panel screen skeleton project 102.

FIG. 17 is a flowchart illustrating the details of a main screen skeleton project creation process of step S65g.

In step G1, the skeleton project creation unit 16 sets a main screen switching operation in the menu button of an intra-screen-classification screen switching menu included in the main screen skeleton project.

An example of the menu button will be described with reference to FIG. 13. For example, in an intra-screen-classification screen switching menu on row B, a menu button for switching to a main screen can be set from the left in an extraction order of the main screens and the sub-screen classifications. Moreover, when there are a number of main screens and sub-screen classifications, a menu switching button for switching a new intra-screen-classification screen switching menu on row B can be set in a menu button of a right-end menu on row B to create the new intra-screen-classification screen switching menu on row B, and a menu button for switching to an extracted main screen can be set from the left end.

In step G2, the skeleton project creation unit 16 stores the created menu button in the control panel screen skeleton project 102.

In step G3, the skeleton project creation unit 16 creates a main screen skeleton project and sets an intra-screen-classification screen switching menu and a screen classification switching menu as a simultaneous display structure.

In step G4, the skeleton project creation unit 16 stores the intra-screen-classification screen switching menu and the main screen switching menu set display in step G3 in the control panel screen skeleton project 102.

FIG. 18 is a flowchart illustrating the details of the single-page sub-screen skeleton project creation process of step S65i.

In step I1, the skeleton project creation unit 16 stores the single-page sub-screen skeleton project created in step I2 in the control panel screen skeleton project 102 as a simultaneous display structure of the main screen. More specifically, the skeleton project creation unit 16 sets such that the single-page sub-screen can be displayed in the skeleton project of the main screen.

In step I2, the skeleton project creation unit 16 creates a single-page sub-screen skeleton project and stores the same in the control panel screen skeleton project 102.

FIG. 19 is a flowchart illustrating the details of a plural-page sub-screen skeleton project creation process of step S65k.

In step K1, when a plural-page sub-screen skeleton project to be created is a starting plural-page sub-screen (K1: YES), the flow proceeds to step K2. When the plural-page sub-screen skeleton project to be created is not a starting plural-page sub-screen (K1: NO), the flow proceeds to step K3.

In step K2, the skeleton project creation unit 16 stores the plural-page sub-screen skeleton project created in step K3 in the control panel screen skeleton project 102 as a simultaneous display structure of the main screen.

In step K3, the skeleton project creation unit 16 stores a plural-page sub-screen skeleton project in which a page switching button is added to the plural-page sub-screen in the control panel screen skeleton project 102. The page switching button may be a button for switching to a forward or backward plural-page sub-screen.

FIG. 20 is flowchart illustrating the details of an entire skeleton project setting process of step S65m.

In step M1, the skeleton project creation unit 16 creates files that describe the attribute values of entire setting items. Here, examples of the entire setting items include a display size and an initial power-on screen.

In step M2, the skeleton project creation unit 16 stores the files created in step Ml in the control panel screen skeleton project 102.

### [4. Advantages of Embodiment]

With the supporting device according to the present embodiment, it is possible to define the dependency between control panel screens visually and design a control panel screen while observing an entire image of a screen structure. Moreover, a menu button for screen transition that follows the dependency between control panel screens is automatically implemented in a skeleton project. Therefore, a screen creator does not need to create setting items necessary for individual control panel screens, and it is possible to improve the efficiency of implementation operations from the viewpoint of shortening a creation time and reducing errors during operations.

The above-described embodiment is a preferred embodiment of the present invention. However, the scope of the present invention is not limited to the embodiment, and various changes can be made without departing from the spirit of the present invention.

Respective devices included in the supporting device 1 can be realized by hardware, software, or a combination thereof. Moreover, a supporting method performed by the respective devices included in the supporting device 1 can be realized by hardware, software, or a combination thereof. Here, the device or the method being realized by software means that the device or the method is realized by a computer reading and executing a program.

The programs can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM (Erasable PROM), a flash ROM, and a RAM (Random Access Memory)). Moreover, the programs may be supplied to a computer via various types of transitory computer readable media. Examples of transitory computer readable media include electrical signals, optical signals and electromagnetic waves. The transitory computer readable media can supply programs to a computer via wired communication paths such as electrical wires and optical fiber, or a wireless communication path.

### EXPLANATION OF REFERENCE NUMERALS

1: Supporting device
11: Screen switching component library
12: Template project library
13: Library control unit
14: Screen structure creation unit
15: Screen structure tree display unit
16: Skeleton project creation unit
101: Screen structure information
102: Control panel screen skeleton project

What is claimed is:

1. A supporting device that, supports creation of control panel screens used in a control panel of an industrial machine, comprising:
a first storage unit that stores screen switching components used for switching screens between the control panel screens;
a second storage unit that stores templates that define a framework of the control panel screens and a layout and a style of the screen switching components on the framework;
a screen structure creation unit that creates screen structure information including the dependency between one or more main screens that form a control panel screen and the dependency between the main screens and one or more sub-screens belonging to each of the main screens as screen structure information of the main screens and the sub-screens;
a screen structure tree display unit that displays a hierarchical structure between the control panel screens in a tree form on the basis of the dependency included in the screen structure information; and
a skeleton project creation unit that creates a skeleton project which is a framework of the control panel screens using the screen switching components, the templates, and the screen structure information on the basis of an operation on a tree displayed by the screen structure tree display unit.

2. The supporting device according to claim 1, wherein
the screen structure creation unit executes addition of a new control panel screen and deletion of an existing control panel screen to and from a designated location on the tree.

3. The supporting device according to claim 1, wherein
the screen structure creation unit sets screen transition between the control panel screens on the basis of an operation on the tree.

4. The supporting device according to claim 1, wherein
the skeleton project creation unit creates a skeleton project which is a framework of the control panel screen on the basis of the screen structure information created by the screen structure creation unit.

5. The supporting device according to claim 1, wherein
the skeleton project includes a framework of the main screen, a framework of the sub-screen, a screen classification in which a plurality of main screens having the same object are grouped, and a project screen structure which is an uppermost framework of the skeleton project.
